(19) United States
(12) Patent Application Publication
(10) Pub. No.: US 2013/0178165 A1
(43) Pub. Date: Jul. 11, 2013

(54) VERY SHORT-RANGE INTERCONNECTION DEVICE BETWEEN COMMUNICATION EQUIPMENT AND A COMMUNICATION NETWORK

(71) Applicants: Maria Coralia Laura Maag, Ste Genevieve des Bois (FR); Jean-Stéphane Martin, Mennecy (FR)

(72) Inventors: Maria Coralia Laura Maag, Ste Genevieve des Bois (FR); Jean-Stéphane Martin, Mennecy (FR)

(73) Assignee: ALCATEL LUCENT, Paris (FR)

(21) Appl. No.: 13/810,990

(22) PCT Filed: Jul. 13, 2011
(86) PCT No.: PCT/FR11/51680

§ 371 Date: Mar. 27, 2013

(30) Foreign Application Priority Data
Jul. 20, 2010 (FR) 1055877

(51) Int. Cl. H04W 4/00

(52) U.S. Cl. CPC H04W 4/008
USPC 455/41.2

(57) ABSTRACT

A device (D) is dedicated to the interconnection between communication equipment (EC), equipped with a very short-range radio communication module (MCR) and a communication network (RC). This device (D) comprises i) relay means (MR) operative to relay received data to and from coupling means (MCP) coupled to said communication network (RC) and ii) an antenna (AN) capable, firstly, of radiating, or respectively capturing, very short-range electromagnetic waves, which are representative of data, to the, or respectively from the, radio communication module (MCR) whenever the communication equipment is placed within its immediate vicinity, and secondly, coupled to the relay means (MR) in order to transmit to them the data to be relayed coming from the radio communication module (MCR), and to receive from them (MR) the relayed data that comes from the coupling means (MCP).

The invention pertains to communication equipment and, more specifically, the interconnection of such communication equipment to communication networks.

In order to be able to connect communication equipment to a communication network, such as the Internet or a local area network (LAN), that communication equipment must comprise a wired or wireless (or radio) communication module.

Whenever the communication module is wired, coupling it to a communication network requires connecting it to a modem (or any equivalent peripheral) by means of a communication cable, then of connecting that modem to a dedicated connector, potentially an Ethernet connector, which is connected to said communication network. Each complete performance of the aforementioned coupling therefore requires many manual operations, which is time-consuming and cumbersome. Additionally, this coupling proves to be visually unappealing, as the connection cables are generally visible. Whenever the communication module is wireless (or radio), coupling it to a wireless communication network—for example, a cellular network or Wireless LAN (WLAN), potentially 802.11 (Wi-Fi) or WiMAX—is done using waves. As those wireless communication networks' radio access points may be relatively distant from the communication equipment that connects to them, the waves must be admitted with a relatively high power in order to have a sufficiently long range. People therefore occupy electromagnetic environments that are more or less dense. There is not currently any consensus regarding the possible danger to health that short-, medium-, or long-term exposure to long-range electromagnetic waves that are used to exchange data with wireless communication networks may cause, given their transmission power. The result is that an increasing number of people refuse to use certain wireless communication networks (cellular or Wi-Fi), as a precautionary principle. Furthermore, interconnection to a radio communication network, particularly a Wi-Fi network, poses real problems of security, as it could enable a malicious third party to connect to the network through the connection used by another person located in his or her immediate vicinity.

As no known solution for interconnection to a communication network is fully satisfactory, the purpose of the invention is therefore to improve the situation.

To that end, it proposes a device dedicated to interconnection between communication equipment, equipped with a very short-range radio communication module, and a communication network, and comprising:
relay means coupled to said antenna and operative (or designed) either to wirelessly relay data received by said antenna to coupling means that are coupled to the communication network, or to relay data received by said coupling means to set antenna so that it can radiate them in the form of very short-range electromagnetic waves to said radio communication module, and a mount to which set antenna and said relay means are joined, and
an antenna that is, firstly, capable of radiating, or respectively capturing, very short-range electromagnetic waves, which are representative of data, to the, or respectively from the, radio communication module whenever the communication equipment is placed within its immediate vicinity, and secondly, coupled to the relay means in order to transmit to them the data to be relayed which comes from the radio communication module, and to receive from them the relayed data that comes from the coupling means.

The inventive device may comprise other characteristics, which may be taken separately or in combination, in particular:
its relay means may be operative to exchange data with the coupling means by wire;
in one variant, its relay means may be operative to exchange data wirelessly with said means of coupling,
   the waves may be infrared;
its antenna may be capable of radiating and capturing very short-range electromagnetic waves that meet the radio communication standard chosen from among (at least) very short-range Wi-Fi and Bluetooth;
it may comprise the coupling means;
   the coupling means may be “power line communication” means, and may be capable of being connected to an electrical power outlet;
   in one variant, the coupling means may be configured in the form of a modem capable of being connected to a wired communication network;
it may comprise a mount that the antenna and relay means are joined to;
   the mount may be capable of being joined with a underside of mounting equipment capable of accommodating the communication equipment;
   the mount may be capable of being placed on the top side of mounting equipment and of accommodating the communication equipment;
   the mount may be configured in the form of a mat.

The invention also proposes mounting equipment comprising an interconnection device of the type presented above. Such equipment may, for example, be configured in the form of a desk.

Other characteristics and advantages of the invention will become apparent upon examining the detailed description below and the attached drawings, wherein:

FIG. 1 very schematically and functionally depicts mounting equipment, of the desk type, equipped with a first example embodiment of an interconnection device according to the invention, and communication equipment of the laptop computer type before it interacts with that interconnection device,

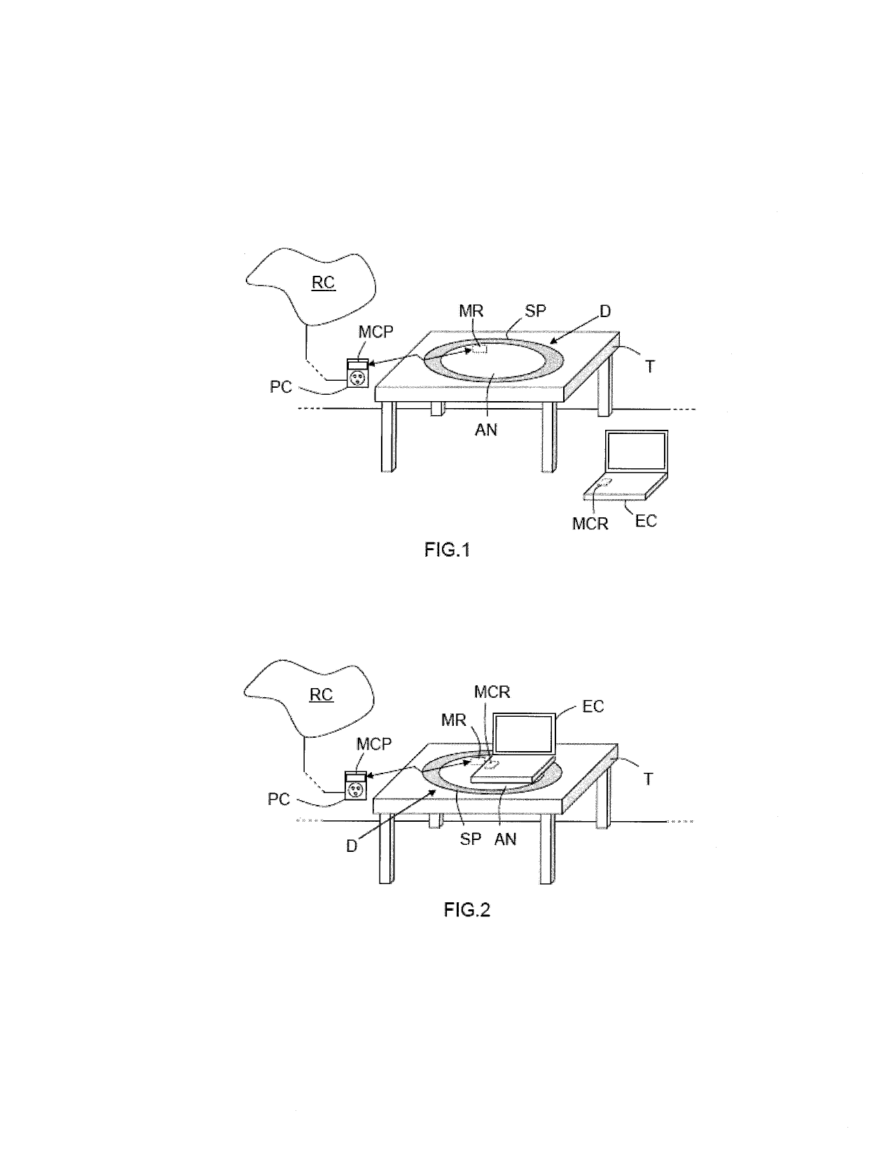

FIG. 2 very schematically and functionally depicts the mounting equipment of FIG. 1 supporting communication equipment of the laptop computer type in a position that allows interaction with its interconnection device, and

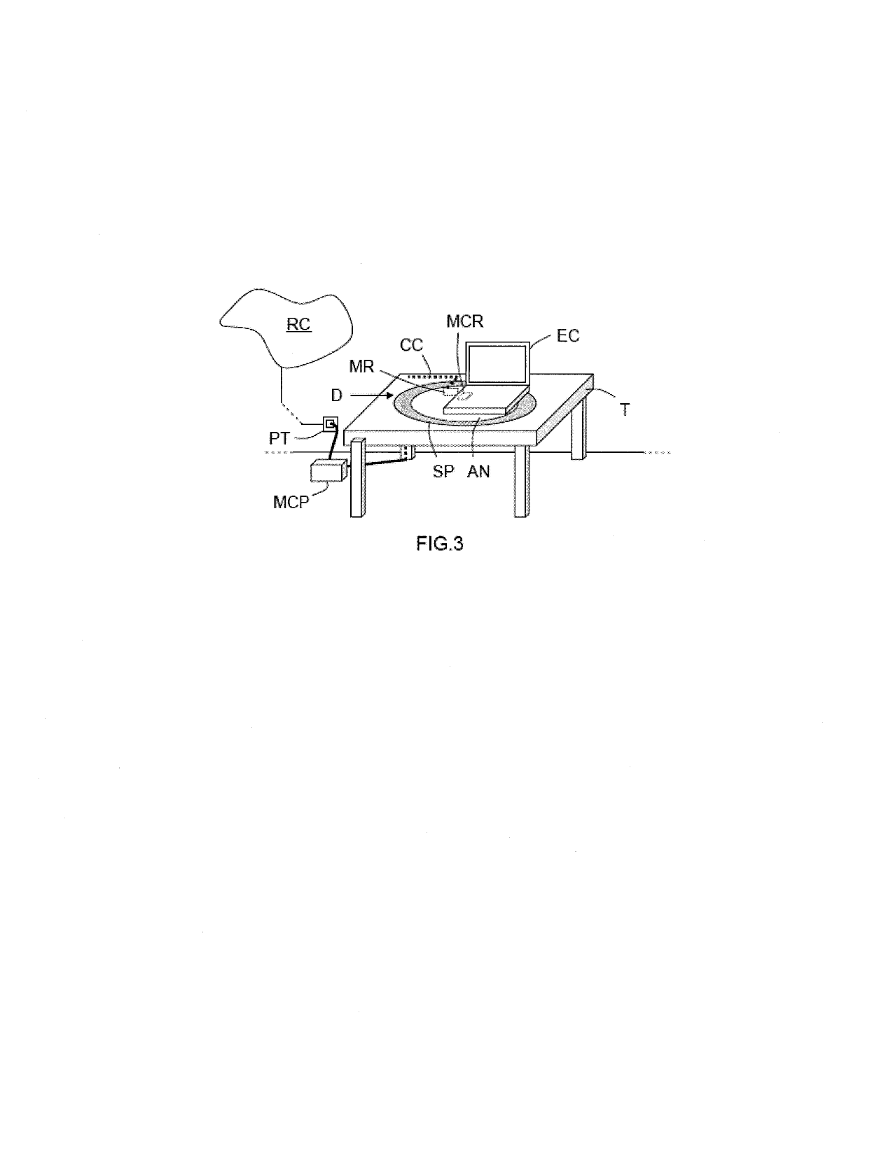

FIG. 3 very schematically and functionally depicts mounting equipment, of the desk type, equipped with a second example embodiment of an interconnection device according to the invention, and supporting communication equipment of the laptop computer type in a position that enables interaction with its interconnection device.

The appended drawings constitute part of the description of the invention as well as contributing to the definition of the invention, if necessary.

It is an object of the invention to offer an interconnection device (D) of a new sort, enabling an interconnection between communication equipment (EC) and a communication network (RC), which is likely to cause minimal risk to human health, and/or prevent malicious third parties from connecting via the connections of other people located in their immediate vicinity.

FIGS. 1 and 2 schematically depict a nonlimiting example of an interconnection device D according to the invention, intended to provide interconnection between communication equipment EC, equipped with at least one very short-range radio communication module MCR (typically less than 20 cm), and a communication network RC when certain conditions are fulfilled, which will be discussed later on.

In the nonlimiting examples depicted in FIGS. 1 to 3, the communication equipment EC is a laptop computer. However, the invention is not limited to this sort of communication equipment. Rather, it pertains to any type of wired and/or wireless (or radio) communication equipment that is capable of exchanging data with other communication equipment or network equipment, via a communication network. Consequently, it may, for example, be a landline or mobile (or cellular) telephone, potentially a smartphone, a desktop or laptop computer, a personal digital assistant (or PDA), a multimedia content receiver (for example a decoder, a residential gateway or a STB (“Set-Top Box”)), provided that it is equipped with at least one very short-range two-way radio communication module MCR.

In what follows, it is assumed by way of a nonlimiting example that the radio communication module MCR is a very short-range Wi-Fi (or Wi-Fi-SD (“Short Distance”)) module. However, the invention is not limited to this sort of radio communication standard. Rather, it pertains to any type of short-distance radio communication standard (and therefore requiring a low, or even very low, transmission power level), and particularly the Bluetooth standard. It should be noted that the radio communication module MCR may be installed within communication equipment EC, or may be an accessory (potentially a “dongle”) that can be coupled to a connector (potentially a USB connector) of communication equipment EC, whenever the inventive device D is to be used.

As depicted in the FIGS. 1 to 3, an inventive (interconnection) device D comprises at least relay means MR and an antenna AN.

The relay means MR are operative (or designed) to relay the data, which they are received in the form of signals, or to coupling means MCP which are coupled to the communication network RC (directly or indirectly), due to the fact that they come from communication equipment EC that interacts with their device D (as depicted in FIGS. 2 and 3), i.e. to the antenna AN due to the fact that they come from the coupling means MCP and are intended for the communication equipment EC (whenever it interacts with the device D).

These relay means MR therefore define, in a certain way, connectivity elements that ensures the relay interface between antenna AN and coupling means MCP.

The antenna AN is coupled, at least electrically, to the relay means MR (for example, they are in direct contact). This antenna AN is capable of radiating and capturing very short-range electromagnetic waves which are representative of exchanged data. To do so, it may be of any type, provided that it has a very low vertical extension. Thus, it may be a patch antenna, or a slot antenna, or a dipole antenna, and more generally, a plate antenna. It should be noted that the place of contact between the antenna AN and the relay means MR depends on the type of antenna AN.

The radiation is intended to transmit, by very short-range waves, to the radio communication module MCR of the communication equipment EC, data that had been provided by the relay means MR (in the form of electrical signals) and which therefore come from a communication network RC. In such a case, the antenna AN converts the received electrical signals into electromagnetic waves (which it transmits).

The capture is intended to receive data transmitted by very short-range waves by the radio communication module MCR of the communication equipment EC, in order to communicate them (in the form of electrical signals) to the relay means MR so that they can communicate with the coupling means MCP due to the fact that they are intended for the communication network RC to which they are connected. In such a case, the antenna AN converts the electromagnetic waves (which it receives) into electrical signals.

It should be understood that the exchange of data by very short-range waves can only be done provided that the communication equipment EC is placed in the immediate vicinity of the antenna AN, as depicted in FIGS. 2 and 3. It should be noted that in the example of FIG. 1, the interaction between the communication equipment EC and the device D is not possible, because the communication equipment EC is too far from the antenna AN.

All types of relay means MR known to the person skilled in the art may be used. Thus, it is possible to use relay means MR that are operative to exchange data by waves with the coupling means MCP, as depicted in a nonlimiting fashion in FIGS. 1 and 2. These waves may be of any type, is provided that they are of low power and limited range, and therefore pose (almost) no danger to anyone's health. Thus, they may be infrared (or IR). In such a case, and as depicted in a nonlimiting fashion in FIGS. 1 and 2, the coupling means MCP may be configured in the form of infrared transmitter/receiver equipment of the “powerline communication” type, and connected directly to an electrical power outlet PC (potentially a wall outlet). This electrical power outlet PC is connected to an electrical network that is coupled to a wired communication network RC.

In one variant, one may use relay means MR that are configured to exchange data by wire with the coupling means MCP, as depicted in a nonlimiting fashion in FIG. 3. In that second example (wired) the relay means MR are connected to the coupling means MCP by means of a communication cable CC. That cable (CC) may, as depicted in a nonlimiting fashion, be integrated into the mounting equipment T which is equipped with the device D and upon which is placed the communication equipment EC. For example, the coupling means MCP may be configured in the form of a modem (or any equivalent equipment) which connected by means of another communication cable to a communication outlet PT (potentially a wall outlet), for example of the Ethernet type. This communication outlet PT may be connected to a wired communication network RC by a telephone cable (xDSL) or by optical fibers.

It should be noted that in one variant, the coupling means MCP may be a simple communication outlet (potentially a wall outlet), and not a modem.

It should also be noted that the coupling means MCP may potentially form part of the device D, regardless of their type.

It should also be noted, as depicted in a nonlimiting fashion in FIGS. 1 to 3, that the antenna AN and the relay means MR may advantageously be joined to a mount SP that in such a case forms part of the device D and whose dimensions are at least equal to those of the antenna AN (in order to properly support it and potentially protect it). Such a mount SP may be rigid or flexible. Thus, it may, for example, be configured in the form of a layer (or a multilayer structure) defining a mat of relatively large dimensions.

For example, one may begin by joining the relay means MR to the mount SP, then one may join the antenna to the mount SP, above the relay means MR, and one may potentially place atop the antenna AN a protective film or protective layer transparent to very short-range electromagnetic waves.

That mount SP may be firmly joined to a underside of mounting equipment T that is capable of accommodating communication equipment EC. This solution is particularly well-suited for support equipment T that is installed in offices, and particularly for those which constitute IT desks or computers.

Here, the term “underside” refers to the side that is opposite the topside intended to support objects.

In one variant, the device D may be a laptop accessory, and therefore may be carried with oneself in order to be able to use it in multiple locations, provided that those locations are located in the immediate vicinity of an electrical power outlet PC. In such a case, the mount SP is configured in such a way that it can be placed on the top side of mounting equipment T (regardless of the type, provided that it can accommodate communication equipment EC). This is particularly true of the nonlimiting examples depicted in FIGS. 1 to 3. It should be noted that in order to facilitate the carrying of the device D, its mount SP and its antenna AN may be flexible.

The invention offers multiple benefits, among them:
a greatly reduced electromagnetic impact on the environment due to the very low power and very short-range of the electromagnetic waves used,
a (very) significant reduction in the power consumption of the transmitting communication equipment, and the end of power consumption by radio access points that until now had been necessary during transmissions to communication equipment,
making the interconnection to a communication network secure, given that only communication equipment that is located in the immediate vicinity of the interconnection device can connect to that network,
very great ease-of-use,
a lower cost.

The invention is not limited to the embodiments of the interconnection device and mounting equipment described above, which are only given by way of example; rather, it encompasses all variants that a person skilled in the art may envision within the framework of the claims below.

1. An interconnection device between communication equipment, equipped with a very short-range radio communication module, and a communication network, said device comprising an antenna capable of radiating, or respectively capturing, very short-range electromagnetic waves, which are representative of data, to said, or respectively from said, radio communication module whenever said communication equipment is placed within its immediate vicinity, wherein it comprises i) relay means coupled to said antenna and operative either to relay by waves data received by said antenna to coupling means coupled to said communication network, or to relay data received by said coupling means to said antenna so that it can radiate them in the form of vary short-range electromagnetic waves to said radio communication module, and ii) a mount to which said antenna and said relay means are joined.

2. A device according to claim 1, wherein said waves are infrared.

3. A device according to claim 1, wherein said antenna is capable of radiating and capturing very short-range electromagnetic waves that need a radio communication standard chosen from a group comprising at least very short-range Wi-Fi and Bluetooth.

4. A device according to claim 1, wherein it comprises said coupling means.

5. A device according to claim 4, wherein said coupling means are of the “power line communication” type and are capable of being connected to an electrical power outlet.

6. A device according to claim 4, wherein said coupling means are configured in the form of a modem capable of being connected to a wired communication network.

7. A device according to claim 1, wherein said mount is capable of being joined to a bottom side of mounting equipment capable of accommodating said communication equipment.

8. A device according to claim 1, wherein said mount is capable of being placed on a top side of mounting equipment capable of accommodating said communication equipment.

9. A device according to claim 1, wherein said mount is configured in the form of a mat.

10. Mounting equipment, wherein it comprises an interconnection device according to claim 1.

11. Equipment according to claim 10, wherein it is configured in the form of a desk.
